(19) United States
(12) Patent Application Publication
(10) Pub. No.: US 2011/0244840 A1
(43) Pub. Date: Oct. 6, 2011

(54) COMMUNICATION SYSTEM WITH CALLER IDENTIFICATION MECHANISM AND METHOD OF OPERATION THEREOF

(75) Inventor: Ky Tang, Milpitas, CA (US)

(73) Assignee: TeleNav, Inc., Sunnyvale, CA (US)

(21) Appl. No.: 12/750,609

(22) Filed: Mar. 30, 2010

(51) Int. Cl. H04M 3/42; H04W 64/00

(52) U.S. Cl. 455/415; 455/456.1

(57) ABSTRACT

A method of operation of a communication system includes: obtaining a current location for locating a calling device; identifying a caller number for identifying the calling device; and selecting a caller location label based on the caller number and the current location for personalizing a description of the current location of the calling device and for displaying on a receiving device.

### TECHNICAL FIELD

The present invention relates generally to a communication system, and more particularly to a communication system with location based service.

### BACKGROUND ART

Modern portable consumer and industrial electronics provide increasing levels of functionality to support modern life including telecommunications and location-based information services. This is especially true for client devices such as navigation systems, cellular phones, portable digital assistants, and multifunction devices.

As users adopt mobile devices with location based services, new and old usage begin to take advantage of this new device space. There are many solutions to take advantage of this new device opportunity. One existing approach is to use location information to provide navigation services, such as a global positioning service (GPS) navigation system for a mobile device. Systems can display map information, navigate and display a route between two points, and enable other services on these devices. Location systems have the ability to locate a device with an ever-increasing degree of accuracy.

Communication system and service providers are continually making improvement in the user's experience in order to be competitive. In communication services, demand for better usability is increasingly important. The provision of more and more location-related information pertaining to a user is one of the most useful and yet challenging features.

In response to consumer demand, communication systems are providing ever-increasing amounts of information requiring these systems to improve usability, performance, and accuracy. This information includes map data, business data, local weather, and local driving conditions. The demand for more information and the need to provide user-friendly experience, low latency, and accuracy continue to challenge the providers of communication systems.

Thus, a need still remains for a communication system with a mechanism for location-based personalized identification. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a communication system including: obtaining a current location for locating a calling device; identifying a caller number for identifying the calling device; and selecting a caller location label based on the caller number and the current location for personalizing a description of the current location of the calling device and for displaying on a receiving device.

The present invention provides a communication system, including: a location module for obtaining a current location for locating a calling device; a place call module, coupled to the location module, for identifying a caller number for identifying the calling device; and a caller location module, coupled to the place call module, for selecting a caller location label based on the caller number and the current location for personalizing a description of the current location of the device, and for displaying on a receiving device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a communication system with caller identification mechanism in a first embodiment of the present invention.

FIG. 2A and FIG. 2B are examples of displays on a display interface of the first device.

FIG. 3 is an exemplary block diagram of the first device.

FIG. 4 is an exemplary block diagram of a communication system with caller identification mechanism in a second embodiment of the present invention.

FIG. 5 is a communication system with caller identification mechanism in a third embodiment of the present invention.

FIG. 6 is a flow chart of a method of operation of the communication system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e. a position of a user.

In an alternative embodiment, navigation information is presented by longitude and latitude related information. In a further embodiment of the present invention, the navigation information also includes a velocity element including a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

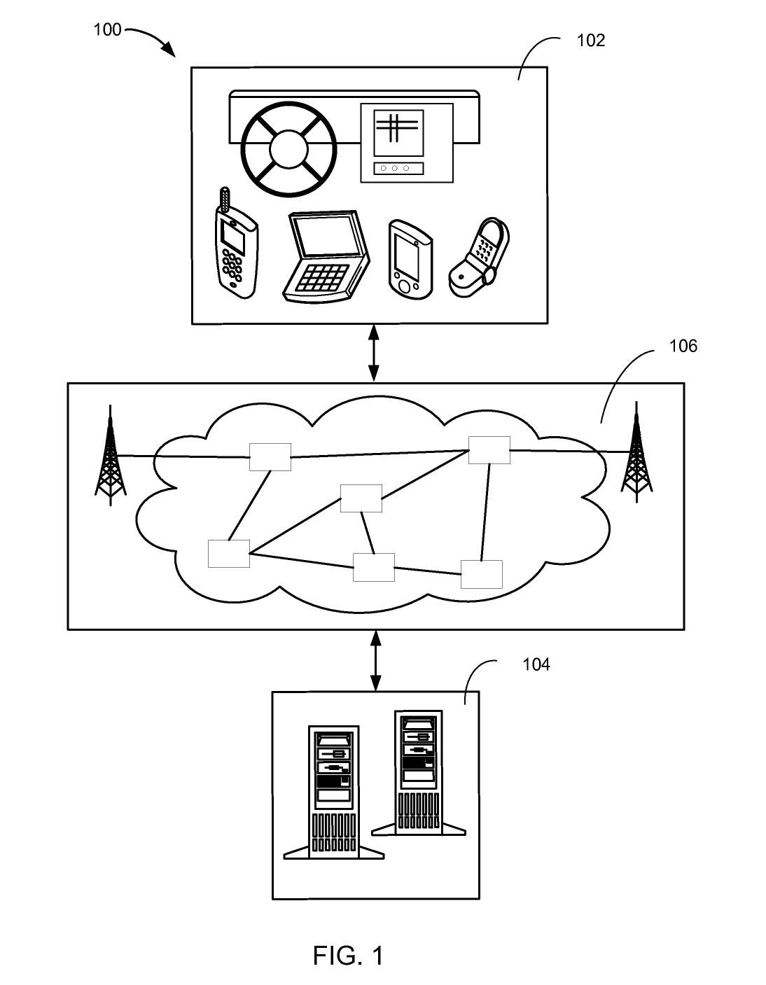

The term “calling device” referred to herein represent a device having communication functions that initiates a communication, as an example a phone call. The calling device may be a mobile or client device, as described in FIG. 1, or a non-mobile or server device, as described in FIG. 1.

The term “receiving device” referred to herein represents a device having communication functions that receives a communication, as an example a phone call. The receiving device may be a mobile or client device, as described in FIG. 1, or a non-mobile or server device, as described in FIG. 1.

Referring now to FIG. 1, therein is shown a communication system 100 with caller identification mechanism in a first embodiment of the present invention. The communication system 100 includes a first device 102, such as a client or a server, connected to a second device 104, such as a client or a server, with a communication path 106, such as a wireless or wired network.

For example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 106 to communicate with the second device 104.

For illustrative purposes, the communication system 100 is described with the first device 102 as a mobile computing device, although it is understood that the first device 102 can be different types of computing devices. For example, the first device 102 can also be a non-mobile computing device, such as a server, a server farm, or a desktop computer.

The second device 104 can be any of a variety of centralized or decentralized computing devices. For example, the second device 104 can be a computer, grid computing resources, a virtualized computer resource, cloud computing resource, routers, switches, peer-to-peer distributed computing devices, or a combination thereof.

The second device 104 can be centralized in a single computer room, distributed across different rooms, distributed across different geographical locations, embedded within a telecommunications network. The second device 104 can have a means for coupling with the communication path 106 to communicate with the first device 102. The second device 104 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 104 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the communication system 100 is described with the second device 104 as a non-mobile computing device, although it is understood that the second device 104 can be different types of computing devices. For example, the second device 104 can also be a mobile computing device, such as notebook computer, another client device, or a different type of client device. The second device 104 can be a standalone device, or can be incorporated with a vehicle, for example a car, truck, bus, or train.

Also for illustrative purposes, the communication system 100 is shown with the second device 104 and the first device 102 as end points of the communication path 106, although it is understood that the communication system 100 can have a different partition between the first device 102, the second device 104, and the communication path 106. For example, the first device 102, the second device 104, or a combination thereof can also function as part of the communication path 106.

The communication path 106 can be a variety of networks. For example, the communication path 106 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

Further, the communication path 106 can traverse a number of network topologies and distances. For example, the communication path 106 can include direct connection, personal area network (PAN), local area network (LAN), metropolitan area network (MAN), wide area network (WAN) or any combination thereof.

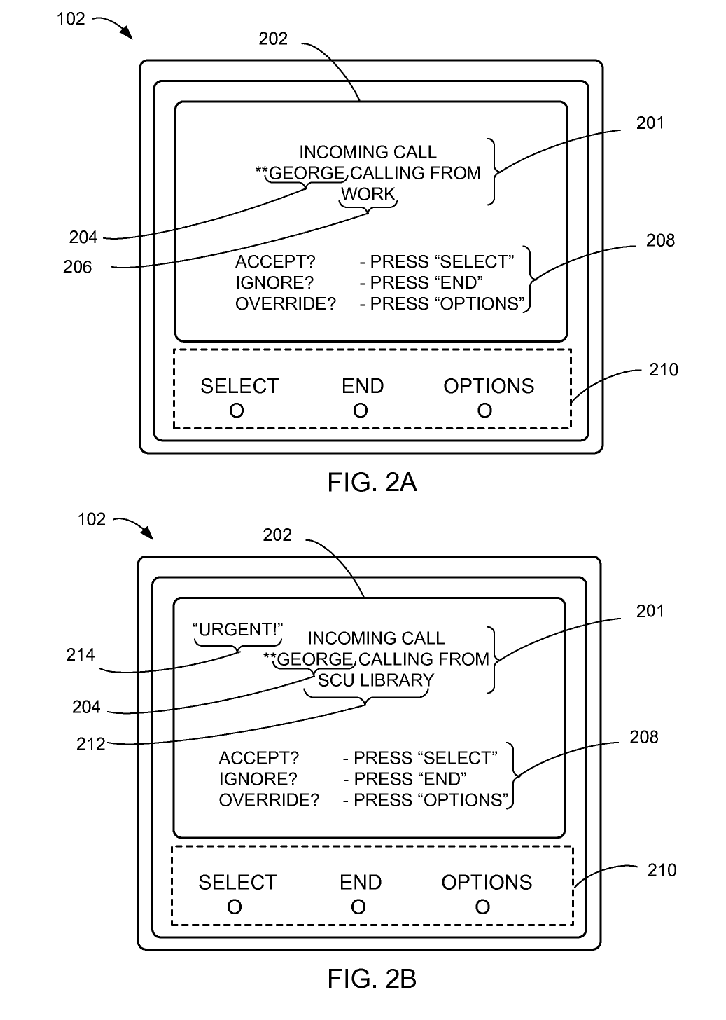

Referring now to FIG. 2A and FIG. 2B, therein are shown examples of displays on a display interface 202 of the first device 102. For example, the first device 102 is functioning as a receiving device with example applications of the communication system 100. The receiving device represents a type of device similar to or the same as the first device 102 of FIG. 1 or the second device 104 of FIG. 1. For convenience and brevity to describe the present invention, a communication from a device to another device can be described as a “call”. For example, a call to the first device 102, here functioning as the receiving device, can be originated from another of the first device 102, here functioning as the calling device. As a further example, the call can be originated from the first device 102, here functioning as the calling device, to the second device 104, here functioning as the receiving device. Examples of a call can include a telephone call, an email message, a Short Message Service (SMS), Multimedia Messaging Service (MMS), or an instant message.

Also, for convenience to describe the present invention, a “caller” can be represented as a device from which a communication can originate. For example, the caller can be the second device 104, or referred to as the calling device, originating a call to the first device 102, or referred to as the receiving device. As a further example, the caller can be another of the first device 102, here functioning as the calling device, originating the call to the first device 102, here functioning as the receiving device.

The illustrations of FIG. 2A and FIG. 2B depict a series of screen shots of the display interface 202 of the communication system 100. The screen shots of FIG. 2A and FIG. 2B depict a presented message 201 displayed on the display interface 202. The presented message 201 can include information about an incoming call, and can be displayed on the display interface 202. In the example displayed in FIG. 2A, the presented message 201 “Incoming Call: George calling from Work” can be informative for a user receiving a call.

The presented message 201 of FIG. 2A can have a caller identification 204. The caller identification 204 represents a brief description of the caller. The caller identification 204 can identify the caller, and is referred to as “Caller ID”. The caller identification 204 can include, for example, a name, a nickname, a phrase, or a combination thereof. The caller identification 204 can be associated with a phone number, an email address, an Internet Protocol (IP) address, or other identification of the sending device. In the example illustrated in FIG. 2A, the caller identification 204 “George” can be a first name of a user initiating the call from the second device 104, functioning as the calling device.

The presented message 201 can include other information. For example, the presented message 201 in FIG. 2A can have a caller location label 206. The caller location label 206 represents a personalized location description, which can identify the caller's location at the time when the call is initiated. Examples of the caller location label 206 can include an establishment name, a function associated with a location, a phrase, or a combination thereof, as it relates to the caller identification 204.

In the example illustrated in FIG. 2A, the caller location label 206 “work” can identify a location associated with the caller identification 204 “George” as a work location. For the caller identification 204 with a different name, the caller location label 206 “work” can represent a different location.

The display interface 202 can also include an options display 208, which can be function selections for dealing with an incoming call. For the example in FIG. 2A and FIG. 2B, the options display 208 includes accepting the call, ignoring the call, or operating an override, which can provide more explicit information. The override function will be described in more detail. The first device 102, functioning as the receiving device, can also include a control console 210, which can be used to select an option for an incoming call. A user of the first device 102, functioning as the receiving device, can make a selection from the options display 208, according to the information included with the presented message 201.

The examples in FIG. 2A and FIG. 2B show how the present invention can benefit consumers. The illustrations depict the first device 102, functioning as a receiving device, receiving a call from another device, such as another of the first device 102 functioning as the calling device. A user of the first device 102 can decide how to deal with the call based on the information included in the presented message 201.

The communication system 100 can be used in a variety of ways. In the illustration of FIG. 2A, the presented message 201 “George Calling from Work”, has the caller identification 204 as “George” and the caller location label 206 as “Work”. The caller identification 204 as “George” can identify an individual associated with the caller. The caller location label 206 “Work” can be associated with the current location of the caller. In this particular example, the caller location label 206 as “Work” can be associated with the work location for the caller identification of “George”, as distinct from a work location for another user.

For example, for the caller identification 204 of “Kathleen” (not shown), the caller location label 206 of “Work” can represent a different physical location, associated with the different caller. If “Kathleen” works at the same location as “George,” then work location for both would be the same.

As a further example, for the presented message 201 “George calling from Home” (not shown), the caller identification 204 can be “George” and the caller location label 206 can be “Home”. Suppose a user, receiving the call on the first device 102 functioning as the receiving device, is surprised that “George” is at “Home” at the time the call is initiated, expecting that “George” would ordinarily be at work at that time. The user with the first device 102 can opt to accept the call to discuss with “George” the unexpected message of the caller location label 206 “Home”. In the earlier example, for the caller location label 206 “Work”, the user with the first device 102 can opt not to accept the call, given that “George” is where he is expected to be.

The communication system 100 can also display greater or lesser levels of detail in the presented message 201. The amount of detail can vary based on privilege-based or time-based considerations, which will be described later.

As in FIG. 2A and FIG. 2B, the caller location label 206 can be personalized, such that the message can be understood by a user, associated with the first device 102 functioning as the receiving device, who is familiar with the caller associated with the caller identification 204, and the location of the caller as it relates to the caller. Without a familiarity with the caller and the caller's location, the message in this example can lose its significance.

The presented message 201 can also include a caller submitted label 212, as shown on the display interface 202 in FIG. 2B. The caller submitted label 212 represents a personalized location text string, which can be displayed in the presented message 201. The caller submitted label 212 can be inputted by a user (not shown) on the receiving device. As in the example shown in FIG. 2B, the caller submitted label 212 can be inputted at the discretion of the caller. The presented message 201 can include the caller submitted label 212 instead of the caller location label 206. The caller submitted label 212 is considered “caller submitted”, because it can be inputted by the caller as the call is being initiated.

As an example of the use of the caller submitted label 212, the caller can initiate a call to the first device 102 functioning as the receiving device, and the presented message 201 can include “Kathleen calling from 501 El Camino Real, Santa Clara, Calif.” with the caller location label 206 as “501 El Camino Real, Santa Clara, Calif.”. This address in this example may not be meaningful when presented on the first device 102. The caller can submit the caller submitted label 212 to provide more meaningful information about the location of the caller. For the example in FIG. 2B, the caller submitted label 212 “SCU Library” can provide a more informative description of the caller's location.

The display interface 202 of FIG. 2B can also include an urgency advisory 214. The urgency advisory 214 can be an indication to a user with the first device 102 functioning as the receiving device that the call is important, in order to prompt the user with the first device 102 to receive the call. As examples, the urgency advisory 214 can include text, a tone, an alarm, an icon, or a combination thereof. In FIG. 2B, for example, the urgency advisory 214 is shown as a text display. As the urgency advisory 214 can be displayed on the display interface of the first device 102, an operator of the first device 102 can recognize the importance of accepting the call, according to the options available on the options display 208.

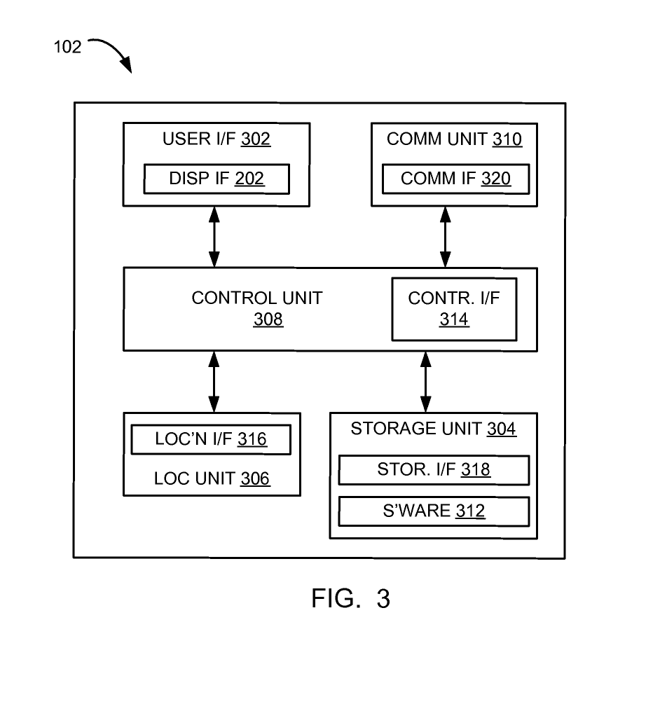

Referring now to FIG. 3, therein is shown an exemplary block diagram of the first device 102. The first device 102 can include a user interface 302, a storage unit 304, a location unit 306, a control unit 308, and a communication unit 310.

The user interface 302 allows a user (not shown) to interface and interact with the first device 102. The user interface 302 can include an input device and an output device. Examples of the input device of the user interface 302 can include a keypad, a touchpad, soft-keys, a keyboard, a microphone, or any combination thereof to provide data and communication inputs. Examples of the output device of the user interface 302 can include the display interface 202. The display interface 202 can include a display, a projector, a video screen, a speaker, or any combination thereof.

The control unit 308 can execute a software 312 to provide the intelligence of the communication system 100. The control unit 308 can operate the user interface 302 to display information generated by the communication system 100. The control unit 308 can also execute the software 312 for the other functions of the communication system 100, including receiving location information from the location unit 306. The control unit 308 can further execute the software 312 for interaction with the communication path 106 of FIG. 1 via the communication unit 310.

The control unit 308 can be implemented in a number of different manners. For example, the control unit 308 can be a processor, an embedded processor, a microprocessor, a hardware control logic, a hardware finite state machine (FSM), a digital signal processor (DSP), or a combination thereof.

The control unit 308 can include a controller interface 314. The controller interface 314 can be used for communication between the control unit 308 and other functional units in the first device 102. The controller interface 314 can also be used for communication that is external to the first device 102.

The controller interface 314 can receive information from the other functional units or from external sources, or can transmit information to the other functional units or to external destinations. The external sources and the external destinations refer to sources and destinations external to the first device 102.

The controller interface 314 can be implemented in different ways and can include different implementations depending on which functional units or external units are being interfaced with the controller interface 314. For example, the controller interface 314 can be implemented with a pressure sensor, an inertial sensor, a microelectromechanical system (MEMS), optical circuitry, waveguides, wireless circuitry, wireline circuitry, or a combination thereof.

The location unit 306 can generate location information, current heading, and current speed of the first device 102, as examples. The location unit 306 can be implemented in many ways. For example, the location unit 306 can function as at least a part of a global positioning system (GPS), an inertial navigation system, a cellular-tower location system, a pressure location system, or any combination thereof.

The location unit 306 can include a location interface 316. The location interface 316 can be used for communication between the location unit 306 and other functional units in the first device 102. The location interface 316 can also be used for communication that is external to the first device 102.

The location interface 316 can receive information from the other functional units or from external sources, or can transmit information to the other functional units or to external destinations. The external sources and the external destinations refer to sources and destinations external to the first device 102.

The location interface 316 can include different implementations depending on which functional units or external units are being interfaced with the location unit 306. The location interface 316 can be implemented with technologies and techniques similar to the implementation of the controller interface 314.

The storage unit 304 can store the software 312. The storage unit 304 can also store the relevant information, such as advertisements, points of interest (POI), navigation routing entries, or any combination thereof.

The storage unit 304 can be a volatile memory, a nonvolatile memory, an internal memory, an external memory, or a combination thereof. For example, the storage unit 304 can be a nonvolatile storage such as non-volatile random access memory (NVRAM), Flash memory, disk storage, or a volatile storage such as static random access memory (SRAM).

The storage unit 304 can include a storage interface 318. The storage interface 318 can be used for communication between the storage unit 304 and other functional units in the first device 102. The storage interface 318 can also be used for communication that is external to the first device 102.

The storage interface 318 can receive information from the other functional units or from external sources, or can transmit information to the other functional units or to external destinations. The external sources and the external destinations refer to sources and destinations external to the first device 102.

The storage interface 318 can include different implementations depending on which functional units or external units are being interfaced with the storage unit 304. The storage interface 318 can be implemented with technologies and techniques similar to the implementation of the controller interface 314.

The communication unit 310 can enable external communication to and from the first device 102. For example, the communication unit 310 can permit the first device 102 to communicate with the second device 104 of FIG. 1, an attachment, such as a peripheral device or a computer desktop, and the communication path 106.

The communication unit 310 can also function as a communication hub allowing the first device 102 to function as part of the communication path 106 and not limited to be an end point or terminal unit to the communication path 106. The communication unit 310 can include active and passive components, such as microelectronics or an antenna, for interaction with the communication path 106.

The communication unit 310 can include a communication interface 320. The communication interface 320 can be used for communication between the communication unit 310 and other functional units in the first device 102. The communication interface 320 can receive information from the other functional units or can transmit information to the other functional units.

The communication interface 320 can include different implementations depending on which functional units are being interfaced with the communication unit 310. The communication interface 320 can be implemented with technologies and techniques similar to the implementation of the controller interface 314.

For illustrative purposes, the communication system 100 is shown with the partition having the user interface 302, the storage unit 304, the location unit 306, the control unit 308, and the communication unit 310 although it is understood that the communication system 100 can have a different partition. For example, the software 312 can be partitioned differently such that some or all of its function can be in the control unit 308, the location unit 306, and the communication unit 310. Also, the first device 102 can include other functional units not shown in FIG. 3 for clarity.

The functional units in the first device 102 can work individually and independently of the other functional units. The first device 102 can work individually and independently from the second device 104 and the communication path 106.

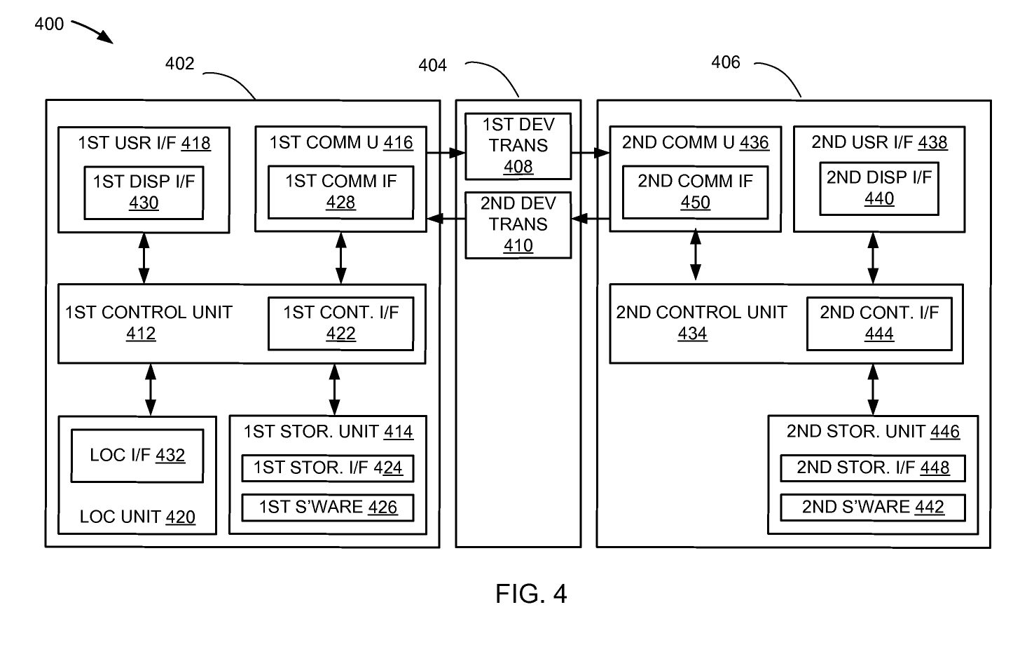

Referring now to FIG. 4, therein is shown an exemplary block diagram of a communication system 400 with caller identification mechanism in a second embodiment of the present invention. The communication system 400 can include a first device 402, a communication path 404, and a second device 406.

The first device 402 can communicate with the second device 406 over the communication path 404. For example, the first device 402, the communication path 404, and the second device 406 can be the first device 102 of FIG. 1, the communication path 106 of FIG. 1, and the second device 104 of FIG. 1, respectively. The screen shot shown on the display interface 202 described in FIG. 2 can represent the screen shot for the communication system 400.

The first device 402 can send information in a first device transmission 408 over the communication path 404 to the second device 406. The second device 406 can send information in a second device transmission 410 over the communication path 404 to the first device 402.

For illustrative purposes, the communication system 400 is shown with the first device 402 as a client device, although it is understood that the communication system 400 can have the first device 402 as a different type of device. For example, the first device 402 can be a server.

Also for illustrative purposes, the communication system 400 is shown with the second device 406 as a server, although it is understood that the communication system 400 can have the second device 406 as a different type of device. For example, the second device 406 can be a client device.

For brevity of description in this embodiment of the present invention, the first device 402 will be described as a client device and the second device 406 will be described as a server device. The present invention is not limited to this selection for the type of devices. The selection is an example of the present invention.

The first device 402 can include a first control unit 412, a first storage unit 414, a first communication unit 416, a first user interface 418, and a location unit 420. The first device 402 can be similarly described by the first device 102.

The first control unit 412 can include a first control interface 422. The first control unit 412 and the first control interface 422 can be similarly described as the control unit 308 of FIG. 3 and the controller interface 314 of FIG. 3, respectively.

The first storage unit 414 can include a first storage interface 424. The first storage unit 414 and the first storage interface 424 can be similarly described as the storage unit 304 of FIG. 3 and storage interface 318 of FIG. 3, respectively. A first software 426 can be stored in the first storage unit 414.

The first communication unit 416 can include a first communication interface 428. The first communication unit 416 and the first communication interface 428 can be similarly described as the communication unit 310 of FIG. 3 and the communication interface 320 of FIG. 3, respectively.

The first user interface 418 can include a first display interface 430. The first user interface 418 and the first display interface 430 can be similarly described as the user interface 302 of FIG. 3 and the display interface 202 of FIG. 3, respectively.

The location unit 420 can include a location interface 432. The location unit 420 and the location interface 432 can be similarly described as the location unit 306 of FIG. 3 and the location interface 316 of FIG. 3, respectively.

The performance, architectures, and type of technologies can also differ between the first device 102 and the first device 402. For example, the first device 102 can function as a single device embodiment of the present invention and can have a higher performance than the first device 402. The first device 402 can be similarly optimized for a multiple device embodiment of the present invention.

For example, the first device 102 can have a higher performance with increased processing power in the control unit 308 compared to the first control unit 412. The storage unit 304 can provide higher storage capacity and access time compared to the first storage unit 414.

Also for example, the first device 402 can be optimized to provide increased communication performance in the first communication unit 416 compared to the communication unit 310. The first storage unit 414 can be sized smaller compared to the storage unit 304. The first software 426 can be smaller than the software 312 of FIG. 3.

The second device 406 can be optimized for implementing the present invention in a multiple device embodiment with the first device 402. The second device 406 can provide the additional or higher performance processing power compared to the first device 402. The second device 406 can include a second control unit 434, a second communication unit 436, and a second user interface 438.

The second user interface 438 allows a user (not shown) to interface and interact with the second device 406. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 104 of the communication system 400. The second software 442 can operate in conjunction with the first software 426. The second control unit 434 can provide additional performance compared to the first control unit 412 or the control unit 308.

The second control unit 434 can operate the second user interface 438 to display information. The second control unit 434 can also execute the second software 442 for the other functions of the communication system 400, including operating the second communication unit 436 to communicate with the first device 402 over the communication path 404.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second controller interface 444. The second controller interface 444 can be used for communication between the second control unit 434 and other functional units in the second device 406. The second controller interface 444 can also be used for communication that is external to the second device 406.

The second controller interface 444 can receive information from the other functional units or from external sources, or can transmit information to the other functional units or to external destinations. The external sources and the external destinations refer to sources and destinations external to the second device 406.

The second controller interface 444 can be implemented in different ways and can include different implementations depending on which functional units or external units are being interfaced with the second controller interface 444. For example, the second controller interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the communication system 400 is shown with the second storage unit 446 as a single hierarchy storage system, although it is understood that the communication system 400 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the second storage unit 446 and other functional units in the second device 406. The second storage interface 448 can also be used for communication that is external to the second device 406.

The second storage interface 448 can receive information from the other functional units or from external sources, or can transmit information to the other functional units or to external destinations. The external sources and the external destinations refer to sources and destinations external to the second device 406.

The second storage interface 448 can include different implementations depending on which functional units or external units are being interfaced with the second storage unit 446. The second storage interface 448 can be implemented with technologies and techniques similar to the implementation of the second controller interface 444.

The second communication unit 436 can enable external communication to and from the second device 406. For example, the second communication unit 436 can permit the second device 406 to communicate with the first device 402 over the communication path 404.

The second communication unit 436 can also function as a communication hub allowing the second device 406 to function as part of the communication path 404 and not limited to be an end point or terminal unit to the communication path 404. The second communication unit 436 can include active and passive components, such as microelectronics or an antenna, for interaction with the communication path 404.

The second communication unit 436 can include a second communication interface 450. The second communication interface 450 can be used for communication between the second communication unit 436 and other functional units in the second device 406. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second controller interface 444.

The first communication unit 416 can couple with the communication path 404 to send information to the second device 406 in the first device transmission 408. The second device 406 can receive information in the second communication unit 436 from the first device transmission 408 of the communication path 404.

The second communication unit 436 can couple with the communication path 404 to send information to the first device 402 in the second device transmission 410. The first device 402 can receive information in the first communication unit 416 from the second device transmission 410 of the communication path 404. The communication system 400 can be executed by the first control unit 412, the second control unit 434, or a combination thereof.

For illustrative purposes, the second device 104 is shown with the partition having the second user interface 438, the second storage unit 446, the second control unit 434, and the second communication unit 436, although it is understood that the second device 104 can have a different partition. For example, the second software 442 can be partitioned differently such that some or all of its function can be in the second control unit 434 and the second communication unit 436. Also, the second device 406 can include other functional units not shown in FIG. 4 for clarity.

The functional units in the first device 402 can work individually and independently of the other functional units. The first device 402 can work individually and independently from the second device 406 and the communication path 404.

The functional units in the second device 406 can work individually and independently of the other functional units. The second device 406 can work individually and independently from the first device 402 and the communication path 404.

For illustrative purposes, the communication system 400 is described by operation of the first device 402 and the second device 406. It is understood that the first device 402 and the second device 406 can operate any of the modules and functions of the communication system 400. For example, the first device 402 is described to operate the location unit 420, although it is understood that the second device 406 can also operate the location unit 420.

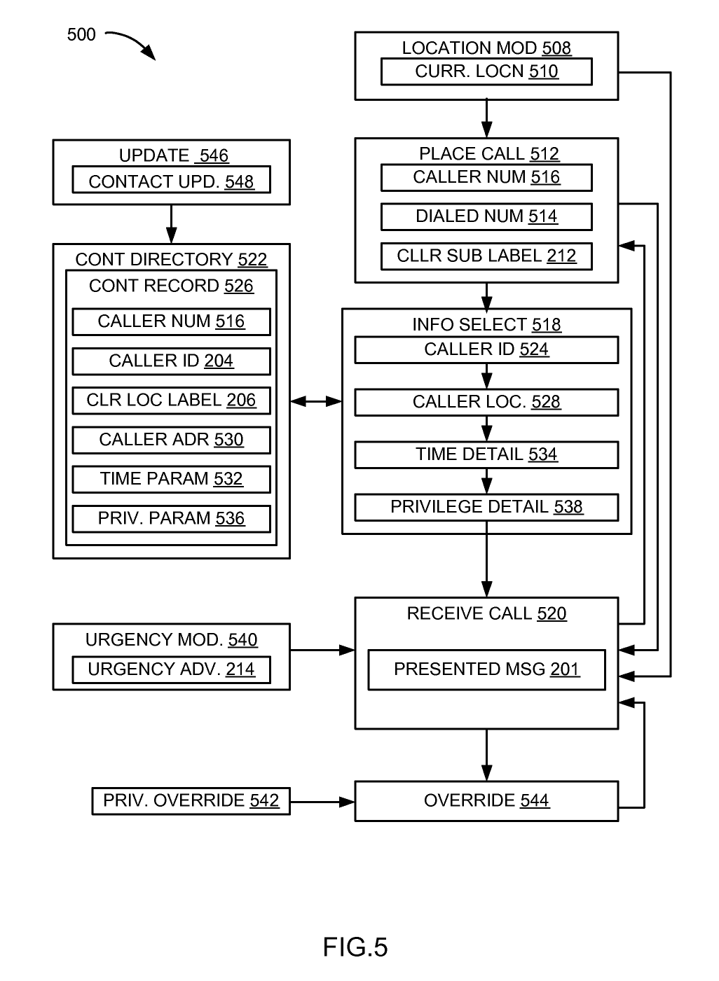

Referring now to FIG. 5, therein is shown a communication system 500 with caller identification mechanism in a third embodiment of the present invention. As an example, the communication system 500 can be operated on the first device 102 of FIG. 3 or the second device 104 of FIG. 1. As a further example, the communication system 500 can be operated on the first device 402 of FIG. 4, the second device 406 of FIG. 4, or partitioned between the two devices.

For brevity of description of the communication system 500, the first device 402, functioning as the calling device, is described initiating a call to the second device 406 functioning as the receiving device, and the second device 406 is described receiving the call from the first device 402. As a different example, the second device 406 can function as the calling device and represent a client device similar to the first device 402. The communication system 500 is not limited to this selection for the type of devices. The selection is an example of the communication system 500.

The communication system 500 can include a location module 508. The location module 508 obtains a current location 510 for locating the first device 402. The current location 510 can be a geographic position of the first device 402, and can be represented as a street address, an intersection of thoroughfares, latitude and longitude coordinates, to identify the position of the first device 402.

Obtaining the current location 510 can mean that the location module 508 can receive the current location 510 of the first device 402 from a positioning system. In the current example, the location unit 420 of FIG. 4 can operate the location module 508 to obtain the current location 510 of the first device 402. As another example, the location unit 306 of FIG. 3 can operate the location module 508. A further example, the location module 508 can receive the current location 510 with the communication unit 310 of FIG. 3, the first communication unit 416 of FIG. 4, or the second communication unit 436 of FIG. 4 from the location unit 420 or the location unit 306. The location module 508 can send the current location 510 to a place call module 512.

The place call module 512 can be invoked to initiate a call from the first device 402 to the second device 406. For example, a dialed number 514 can be received by the place call module 512 with an input to the first user interface 418 of FIG. 4 of the first device 402 and through the second communication unit 436. As a further example, the dialed number 514 can be received by the place call module 512 with the input to the user interface 302 of FIG. 3, through the communication unit 310, or a combination thereof.

The dialed number 514 represents one way to identify the receiving device, such as the second device 406, preferably in the possession of the intended recipient of the call. Suppose the first device 402 and the second device 406 are telephones or have telephone functions, then the dialed number 514 can be the telephone number of the second device 406, and the dialed number 514 can be inputted on a keypad of the first device 402.

The place call module 512 can also identify a caller when the first device 402 or the second device 406 receives a call. A caller number 516 can be used for identifying the caller. The caller can be another of the first device 402 or the second device 406. The caller number 516 can represent a unique identification of the first device 402 or the device initiating the call. In the example of the first device 402 and the second device 406 as telephones, the caller number 516 can be the telephone number of the first device 402 or the second device 406, whichever initiated the call.

The place call module 512 can also input or receive the caller submitted label 212 for displaying on the second device 406 or the first device 402, whichever is receiving the call. If a user with the first device 402 chooses to submit the caller submitted label 212, the caller submitted label 212 can be entered in or received by the place call module 512.

The place call module 512 can send the caller number 516 and the dialed number 514 to an information selection module 518. If the place call module 512 inputs the caller submitted label 212, then the place call module 512 can send the caller submitted label 212 to a receive call module 520 for displaying on the second device 406. The receive call module 520 will be described later in more detail.

The place call module 512 can be implemented in the communication system 400. For example, a user (not shown) can input the dialed number 514, the caller submitted label 212, or a combination thereof on the first user interface 418. The first control unit 412 of FIG. 4 can identify the caller number 516. The first communication unit 416 can send the caller number 516, the dialed number 514, and the caller submitted label 212 to another device, such as the second device 406, which can be identified by the dialed number 514. As a further example, the second communication unit 436 can receive the caller submitted label 212 as an input to the place call module 512 in the second device 406. The second control unit 434 of FIG. 4 can identify the caller number 516.

The place call module 512 can also be implemented on the first device 102 of FIG. 3. In this example, the dialed number 514, the caller submitted label 212, or a combination thereof can be manually entered on or selected through the user interface 302 of FIG. 3. The control unit 308 can identify the caller number 516. The place call module 512 can receive the caller submitted label 212 or can read the caller submitted label 212 from the storage unit 304 of FIG. 3.

The purpose of the information selection module 518 is to select the information to be displayed in the presented message 201 of FIG. 2. The presented message 201 can be displayed on the first device 102, the second device 104, the first device 402, or the second device 406. For example, the presented message 201 can be displayed when a call is initiated from the first device 402 to the second device 406. The information selection module 518 can receive the caller number 516 and the dialed number 514.

The information selection module 518 can select the presented message 201 in a number of ways. For example, the information selection module 518 can use the caller number 516, the current location 510, or a combination thereof to retrieve and filter specific information from a contact directory 522, as will be described later. The information selection module 518 can include other modules, each of which can select the information from the contact directory 522.

The information selection module 518 can include a caller identification module 524. The purpose of the caller identification module 524 is to determine whether a record of information associated with the caller is available to the communication system 500. If there is a record associated with the caller, the caller identification module 524 can retrieve the caller identification 204 associated with the first device 402. As described, the caller number 516 can be a string of characters, numbers, or a combination thereof, which can identify the first device 402.

The caller identification module 524 can scan the contact directory 522 for locating a contact record 526 with the caller number 516. The caller identification module 524 can compare the caller number 516 received from the place call module 512 with another of the caller number 516 in the contact record 526. If the caller number 516 matches the caller number 516 in the contact record 526, then the caller identification module 524 recognizes that the contact record 526 is related to the first device 402. The caller identification module 524 can also retrieve the caller identification 204 from the contact record 526 for displaying on the second device 406. Otherwise the caller identification module 524 can move to another of the contact record 526 to continue to search for a match.

If the caller identification module 524 does not find the caller number 516 in the contact directory 522 or more specifically does not find the contact record 526 associated with the first device 402, the caller identification module 524 can send the caller number 516 and the current location 510 to the receive call module 520. As an example, for an unknown caller calling the second device 406, the communication system 500 can display the caller number 516 in the presented message 201.

In the example of the first device 402 and the second device 406 having telephone functions, the caller number 516 associated with the first device 402 can be a number. The caller identification module 524 can compare the telephone numbers included to determine whether the contact record 526 relates to the first device 402.

The caller identification module 524 can be implemented in the communication system 400. For example, the second control unit 434 can scan the contact directory 522, and compare the caller number 516 from the place call module 512 with the contact directory 522 or more specifically the caller number 516 in the contact record 526. The second storage unit 446 can store the contact directory 522, and the second control unit 434 can access the second storage unit 446 to scan the contact directory 522.

The caller identification module 524 can also be implemented on the first device 102 of FIG. 3. In this example, the storage unit 304 can store the contact directory 522, and the control unit 308 can access the storage unit 304 to scan the contact directory 522 for the contact record 526. The control unit 308 can also compare the caller number 516 from the place call module 512 with the caller number 516 in the contact record 526.

When the caller identification module 524 recognizes that the contact record 526 relates to the first device 402 as the caller, a caller location module 528 can scan the contact record 526. The purpose of the caller location module 528 is to determine whether the contact record 526, which relates to the first device 402, also relates to the current location 510 of the first device 402. The caller location module 528 can also select the caller location label 206 for personalizing the current location 510 of the first device 402, and for displaying on the second device 406.

In the example of FIG. 2A, the caller location label 206 in the presented message 201 can be selected from the contact record 526 by the caller location module 528 with a match of the current location 510 to a caller address 530 in the contact record 526. The caller location module 528 can compare the current location 510 with the caller address 530 in the contact record 526. The caller address 530 represents a location designation. The caller address 530 can be a geographic position or location, a postal address, an intersection, or any meaningful location designation used by country standard or local standard.

Without a match between the current location 510 and the caller address 530, the caller location module 528 recognizes that the first device 402 is not at the location described by the caller address 530. The communication system 500 can recognize that this can be an example of a caller, known to the intended recipient, calling from a location not frequented by the caller. In this example, the communication system 500 can display the caller identification 204 and the current location 510 on the second device 406. As an example, the presented message 201 can be “Kathleen calling from 501 El Camino Real, Santa Clara, Calif.” (not shown), with the caller identification 204 as “Kathleen” and the current location 510 as “501 El Camino Real, Santa Clara, Calif.”.

The caller location module 528 can be implemented in the communication system 400. For example, the second control unit 434 can scan the contact record 526 from the second storage unit 446, and compare the current location 510 with the caller address 530. The second control unit 434 can also select the caller location label 206 for personalizing the current location 510 of the first device 402, and for displaying on the second device 406.

The caller location module 528 can also be implemented on the first device 102 of FIG. 3. In this example, the control unit 308 can access the storage unit 304 to compare the current location 510 with the caller address 530. The control unit 308 can also select the caller location label 206 for personalizing the current location 510 of the first device 102, and for displaying on the second device 104.

If the caller location module 528 determines a match of the current location 510 of the first device 402 and the caller address 530 in the contact record 526, and if the contact record 526 includes a time constraint 532, then the communication system 500 can operate a time detail module 534. The purpose of the time detail module 534 is to tailor the information presented on the second device 406 as dictated by the time constraint 532. The time detail module 534 can retrieve the time constraint 532 from the contact record 526 for displaying the detail of the caller location label 206 on the second device 406.

The time detail module 534 can identify the time constraint 532 to assert lower or higher levels of detail presented in the caller location label 206 or for the current location 510. The time constraint 532 can include a range of hours in the day, days in the week, or other timescale. The time range included in the time constraint 532 can represent times when the communication system 500 can curtail the detail displayed on the second device 406 functioning as the receiving device.

The time detail module 534 can compare the time of the call with the time constraint 532. If the call is placed at a time within the time constraint 532, then the amount of detail presented on the second device 406 can be reduced. Conversely, for a call placed outside the time constraint 532, there is no curtailment of detail displayed on the second device 406.

For example, if the first device 402 initiates a call during the daytime, the display on the second device 406 can include the current location 510 as “501 El Camino Real, Santa Clara, Calif.”. As a further example, if the first device 402 initiates a call during the nighttime, the display on the second device 406 can include a curtailed version of the current location 510 as “Santa Clara, Calif.”, or “California, USA”.

This can be achieved in a number of ways. For example, the current location 510 can be split into fields, each with portion of the current location 510. The time detail module 534 can select all the fields when a call is initiated outside the time constraint 532. For a call initiated inside the time constraint 532, the time detail module 534 can parse the current location 510 to select a reduced number of the fields of the current location 510.

As a further example, the time constraint 532 can define a constrained time window for non-working hours. In this example, if the first device 402 initiates a call during the work hours, the display on the second device 406 can include the caller location label 206 as “Green Conference Room, Building B, Kifer & Lawrence”. If the first device 402 initiates a call during the nighttime or outside the time constraint 532 the time detail module 534 can curtail the detail of the display, and the current location 510 can include “Kifer & Lawrence”.

As with the previous example, the detail included with the display can be achieved by splitting the caller location label 206 into fields. The time detail module 534 can parse the caller location label 206 to select some or all of the fields of the caller location label 206 depending on the time constraint 532 and the time of the call.

Another way of achieving the different levels of detail can include using different versions of the caller location label 206 and the current location 510. The different versions can have more or less detail at the discretion of the user. In this example, the time detail module 534 can select the appropriate version of the current location 510 depending on the time constraint 532 and the time of the call. In a similar way, different versions of the caller location label 206 can enable different levels of detail.

For illustrative purposes, the communication system 500 includes the time detail module 534 providing location information based on the time constraint 532 being satisfied or not along with the time of the call, although it is understood that the time detail module 534 can operate differently. For example, the communication system 500 can operate the time detail module 534 and the time constraint 532 based on the time at the person receiving the call as opposed to the time the person initiating the call.

Also for illustrative purposes, the communication system 500 includes the time detail module 534 providing different location information based on the time constraint 532 being satisfied or not along with the time of the call, although it is understood that the time detail module 534 can operate differently. For example, the communication system 500 can operate the time detail module 534 and the time constraint 532 to determine whether or not to provide any location information.

The time detail module 534 can be implemented in the communication system 400. For example, the second control unit 434 can receive the time constraint 532 from the contact record 526, and select the current location 510 or the caller location label 206 for displaying on the second device 406. The time constraint 532 can be calculated or provided by the first device 402 or the second device 406. The time constraint 532 can be read from the first storage unit 414 or calculated with the first control unit 412. The time constraint 532 can be read from the second storage unit 446 or calculated with the second control unit 434.

The time detail module 534 can also be implemented on the first device 102 of FIG. 3. In this example, the control unit 308 can receive the time constraint 532 from the contact record 526, and select the current location 510 or the caller location label 206 for displaying on the second device 406. The time constraint 532 can be calculated or provided by the first device 102 or the second device 104. The time constraint 532 can be read from the storage unit 304 or calculated with the control unit 308.

If the caller location module 528 determines a match of the current location 510 of the first device 402 with the caller address 530 in the contact record 526, and if the contact record 526 includes a caller privilege 536, then the communication system 500 can operate a privilege detail module 538. The purpose of the privilege detail module 538 is to tailor the information presented on the second device 406 as dictated by the caller privilege 536.

The caller privilege 536 can be a tag, or an identifier, which can denote that the recipient of the call has an entitlement to higher levels of detail presented in the caller location label 206 or the current location 510. The absence or an appropriate level of the caller privilege 536 identifies that the recipient of the call does not have an appropriate level of privilege to access details or some of the details in the caller location label 206 or the current location 510. Examples of a recipient with this level of privilege can include senior management, a spouse, or a parent.

The privilege detail module 538 can retrieve the caller privilege 536 for displaying the detail of the caller location label 206 on the device. The privilege detail module 538 identifies the caller privilege 536 to enable access to some or all of the details of the caller location label 206 or the current location 510.

If the first device 402 initiates a call to the second device 406, and if the privilege detail module 538 retrieves the caller privilege 536 in the contact record 526, then the amount of detail of the caller location label 206 or the current location 510 presented on the second device 406 can be unrestricted. In this example, the user of the second device 406 can be a privileged associate of the user of the first device 402, and can receive unconstrained detail in the display. Conversely, if the caller privilege 536 is not included in the contact record 526, there is no curtailment of detail displayed on the second device 406.

For example, the varying detail provided by the privilege detail module 538 can be achieved by splitting the current location 510 into fields, each with portion of the current location 510. The privilege detail module 538 can select all the fields when the privilege detail module 538 receives the caller privilege 536 or a reduced number of fields when the contact record 526 does not include the caller privilege 536.

As a further example, the caller privilege 536 can determine a level of detail presented in the caller location label 206, if the caller location label 206 is included with the contact record 526. If the first device 402 initiates a call to the second device 406, preferably in the possession of a privileged recipient, the display on the second device 406 can include the caller location label 206 as “Green Conference Room, Building B, Kifer & Lawrence”. For a call to a non-privileged recipient, wherein the contact record 526 does not include the caller privilege 536, the caller location label 206 can include “Building B, Kifer & Lawrence”, or simply “Kifer & Lawrence”.

As with the previous example, the detail included with the display can be achieved by splitting the caller location label 206 into fields. The privilege detail module 538 can parse the caller location label 206 to select some or all of the fields of the caller location label 206 depending on the caller privilege 536.

Another way of achieving the different levels of detail can include using different versions of the caller location label 206 and the current location 510, the different versions having more or less detail at the discretion of the user. In this example, the privilege detail module 538 can select the appropriate version of the current location 510 depending on the caller privilege 536. In a similar way, different versions of the caller location label 206 can enable different levels of detail.

The privilege detail module 538 can be implemented in the communication system 400. For example, the second control unit 434 can scan the contact record 526 from the second storage unit 446, and can also receive the time constraint 532 from the contact record 526.

The privilege detail module 538 can also be implemented on the first device 102 of FIG. 3. In this example, the control unit 308 can scan the contact record 526 from the storage unit 304, and can also receive the time constraint 532 from the contact record 526.

For a call from the first device 402 to the second device 406, the modules of the information selection module 518 can also select the caller identification 204, if available and relevant for a call. The modules of the information selection module 518 can also select the caller location label 206 or the current location 510 for display on the second device 406.

The information selection module 518 can send the caller number 516 or the caller identification 204 to the receive call module 520. The information selection module 518 can also send the current location 510 or the caller location label 206 to the receive call module 520.

An urgency module 540 coupled to the receive call module 520 can receive the urgency advisory 214 for displaying on the second device 406. For example, the urgency advisory 214 can be submitted on an input of the communication system 500 in the urgency module 540. The urgency module 540 can send the urgency advisory 214 to the receive call module 520. The receive call module 520 can receive the urgency advisory 214 for displaying on the second device 406. As an example, the screen shot of FIG. 2B includes the urgency advisory 214 as a prompt to the recipient to accept the call.

The urgency module 540 can be implemented in the communication system 400. For example, the urgency advisory 214 can be submitted on the first user interface 418. The second control unit 434 can couple to the second user interface 438 to display the urgency advisory 214.

The urgency module 540 can also be implemented on the first device 102 of FIG. 3. In this example, the urgency advisory 214 can be submitted on the user interface 302. The control unit 308 can couple to the user interface 302 to display the urgency advisory 214.

The receive call module 520 can also receive the caller number 516 or the caller identification 204 from the information selection module 518. The receive call module 520 can also receive the current location 510 or the caller location label 206 from the information selection module 518. The receive call module 520 can generate the presented message 201 for display on the second device 406.

For example, the receive call module 520 can generate the presented message 201 by selecting the caller number 516 and the current location 510. In this example, the receive call module 520 can generate the presented message 201 as “408-555-1212 calling from Kifer Rd at Lawrence, Sunnyvale”, having the caller number 516 as “408-555-1212” and the current location 510 as “Kifer Rd at Lawrence”.

As a further example, the receive call module 520 can generate the presented message 201 by selecting the caller identification 204 and the caller location label 206. In this example, the receive call module 520 can generate the presented message 201 as “408-555-1212 calling from Kifer Rd at Lawrence, Sunnyvale”, having the caller number 516 as “408-555-1212” and the current location 510 as “Kifer Rd at Lawrence”.

The receive call module 520 can display the caller number 516 or the caller identification 204 on a display of the second device 406 as part of the presented message 201. The receive call module 520 can also display the current location 510 or the caller location label 206 on a display of the second device 406.

The receive call module 520 can also receive the caller submitted label 212 from the place call module 512. As described earlier, the caller submitted label 212 can be a personalized description of the caller's location, and can be submitted as the call is initiated, whereas the caller location label 206 can be a personalized description stored in, and received from, the contact record 526.

The caller submitted label 212 can be included with the presented message 201, and can supersede either the current location 510 or the caller location label 206 in the presented message 201. Example usage of the caller submitted label 212 can include the first device 402 initiating a call to the second device 406 from a location not usually associated with the caller, or with additional information not included with the caller location label 206.

As an example of the caller submitted label 212 superseding the caller location label 206, for a call with the caller identification 204 as “George”, and the caller location label 206 as “work”, the presented message 201 on the second device 406 can be “George calling from Work”. If “George” initiates the same call with the caller submitted label 212 as “work: but I'm leaving early”, the presented message 201 on the second device 406 can read “George calling from work: but I'm taking the afternoon off”. The caller submitted label 212 can provide more information about the caller's location for the benefit of the recipient with the second device 406.

As an example of the caller submitted label 212 superseding the current location 510, for a call with the caller identification 204 as “Kathleen”, the current location 510 as “501 El Camino Real, Santa Clara, Calif.”, the presented message 201 on the second device 406 can be “Kathleen calling from 501 El Camino Real, Santa Clara, Calif.”. If the user “Kathleen” initiates the same call with the caller submitted label 212 as “Main Library, SCU, and I am stuck with a flat tire!” the presented message 201 on the second device 406 can be “Kathleen calling from Main Library, SCU, and I am stuck with a flat tire!”

In this example, the text included with the caller submitted label 212 can impart an urgency. This urgency in the caller submitted label 212 can enhance the urgency indicated by the urgency advisory 214.

The caller submitted label 212 can be used to mask or hide an accurate location. For example, a child with the first device 402 at a park can initiate a call to the child's parent with the caller submitted label 212 as “school”. The presented message 201 can be “Dave calling from school”. This could lead the parent to expect that the child with the first device 402 is safely in school, while in reality, the child can be in an unsafe place.

The communication system 500 can receive a privacy override 542 in an override module 544. The purpose of the override module 544 is to enable a user with the second device 406 to retrieve the current location 510 for displaying on the second device 406. For example, while the caller submitted label 212 can supersede the caller location label 206 or the current location 510, the override module 544 can retrieve the current location 510 of the first device 402 from the location module 508 for display on the second device 406. This enables the communication system 500 to provide unambiguous location information for the first device 402.

In the example of the child submitting the caller submitted label 212 as “school”, the presented message 201 displayed on the second device 406 can be “Nick calling from school”. The child's parent, with the second device 406, can submit the privacy override 542 on the second device 406, on an input of the second device 406, to the override module 544.

The override module 544 can send the privacy override 542 to the receive call module 520. The privacy override 542 allows the receive call module 520 to extract the current location 510 for the calling device from the location module 508, and can overriding the caller submitted label 212 in the presented message 201 with the current location 510.

The override module 544 can be implemented in the communication system 400. For example, the privacy override 542 can be submitted on the second user interface 438. The location unit 420 can obtain the current location 510, and the second control unit 434 can couple to the second user interface 438 to display the current location 510.

The override module 544 can also be implemented on the first device 102. In this example, the privacy override 542 can be submitted on the user interface 302. The location unit 306 can obtain the current location 510, and the control unit 308 can couple to the user interface 302 to display the current location 510.

Once the second device 406 selects a function for dealing with an incoming call, the communication system 500 can return to the receive call module 520. The functions can include answering the call, for example, a telephone call. Another example is submitting the privacy override 542 as has been described.

The communication system 500 can also include an update module 546 to update the contact record 526, for storing the caller number 516, the caller address 530 and the caller location label 206. The purpose of the update module 546 is to receive and store changes to the contact record 526, or to receive and store another of the contact record 526.

The update module 546 can receive a contact update 548. The contact update 548 can be a revised version of the contact record 526, wherein there may be changes to the information in the contact record 526 which is already in the contact directory 522. The changes can include a modification to existing data, or new data that is additional to the contact record 526. As an example, for a user of the first device 402 who is starting a new job, the contact record 526 can include the caller number 516, the caller address 530, and the caller location label 206 as “work”. For a new workplace, the user of the first device 402 can submit the contact update 548, with a new version of the caller address 530 associated with the caller location label 206 “work”.

As a further example, the contact record 526 can be updated with additional record information. If the user of the first device 402 goes on vacation, the contact update 548 can add the time constraint 532. The time constraint 532 can describe the time of the vacation, and the caller location label 206 can be “on vacation” for the duration of the time constraint 532. In this example, the caller submitted label 212 is disassociated with the current location 510 of the calling device.

As an example of a new record being added, the contact update 548 can be information for a new user, or another of the contact record 526 for an existing user. For example, the user of the first device 402 can join a gym, and the update module 546 can receive the contact update 548 with a new version of the contact record 526, with the caller number 516, the caller address 530 being the address of the gym, and the caller location label 206 being “the new gym”.

Thus, if the user of the first device 402 places a call from the user's workplace, the presented message 201 on the second device 406 can be “George calling from work”, having selected the caller identification 204 and the caller location label 206 from one of the contact record 526. If the user of the first device 402 initiates a call from the gym, the presented message 201 can be “George calling from the gym”, having selected the caller identification 204 and the caller location label 206 from another of the contact record 526.

It has been discovered that the communication system 500 with location identification mechanism can provide personalized information to a recipient of a call about the location of a caller. The caller location label 206 can include such information to provide a meaningful description of a caller's location, and how it is associated with the caller. The communication system 500 can adapt the detail presented to the recipient with the time constraint 532, the caller privilege 536, or a combination thereof. Further, the urgency of a call can be conveyed to the recipient with the urgency advisory 214. The recipient can consider all aspects of the information presented before deciding to receive the call.

It has also been discovered that the communication system 500 with location identification mechanism can enable a caller to send a real-time description of the caller's location with the caller submitted label 212. The caller submitted label 212 can enable the recipient to understand the location of the caller, even in an unfamiliar or unexpected location.

It has been unexpectedly discovered that the privacy override 542 can assist with the safety of users. A parent receiving a call from a juvenile can override the caller submitted label 212 with the privacy override 542, and can receive the current location 510 of the juvenile, thereby informing the parent of the true location of the juvenile. This feature can be used in a wider context, such as a dispatcher monitoring the location of a cab driver, or a sales manager monitoring a sales representative.

The physical transformation of the caller identification 204 and the caller location label 206 results in movement in the physical world, such as people using the first device 402, the second device 406, or vehicles, based on the operation of the communication system 400. As the movement in the physical world occurs, the movement itself creates additional information that is converted back to the caller identification 204 or the caller location label 206 for the continued operation of the communication system 500 and to continue the movement in the physical world.

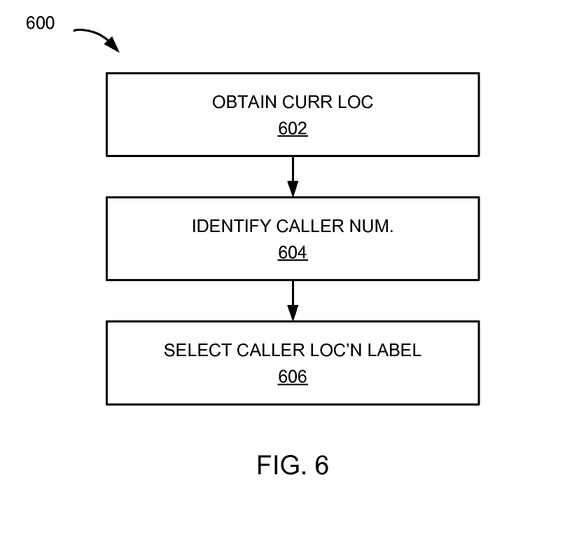

Referring now to FIG. 6, therein is shown a flow chart of a method 600 of operation of the communication system 500 in a further embodiment of the present invention. The method 600 includes: obtaining a current location for locating a calling device in a block 602; identifying a caller number for identifying the calling device in a block 604; and selecting a caller location label based on the caller number and the current location for personalizing a description of the current location of the calling device and for displaying on a receiving device in a block 606.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a communication system comprising:
obtaining a current location for locating a calling device;
identifying a caller number for identifying the calling device; and
selecting a caller location label based on the caller number and the current location for personalizing a description of the current location of the calling device and for displaying on a receiving device.

2. The method as claimed in claim 1 further comprising receiving a caller submitted label for displaying on the receiving device and for personalizing a description of the current location of the calling device through an entry at the calling device.

3. The method as claimed in claim 1 further comprising:
receiving a caller submitted label for displaying on the receiving device and for personalizing a description of the current location of the calling device through an entry at the calling device; and
overriding the caller submitted label with the current location with a privacy override.

4. The method as claimed in claim 1 further comprising identifying a time constraint to assert a lower or a higher level of detail in the caller location label.

5. The method as claimed in claim 1 further comprising identifying a caller privilege for enabling access to a detail of the caller location label.

6. A method of operation of a communication system comprising:
obtaining a current location for locating a calling device;
identifying a caller number for identifying the calling device;
selecting a caller location label based on the caller number and the current location for personalizing a description of the current location of the calling device, and for displaying on a receiving device;
identifying a time constraint to assert a lower or a higher level of detail in the caller location label; and
identifying a caller privilege for enabling access to a detail of the caller location label.

7. The method as claimed in claim 6 further comprising receiving an urgency advisory for displaying on the receiving device.

8. The method as claimed in claim 6 further comprising:
receiving a caller submitted label for personalizing a description of the current location of the calling device through an entry at the calling device; and
superseding the caller location label with the caller submitted label for displaying at the receiving device.

9. The method as claimed in claim 6 further comprising:
identifying the time constraint to assert a lower or a higher level of detail in the caller location label; and
updating the caller location label with the time constraint.

10. The method as claimed in claim 6 further comprising disassociating the caller submitted label with the current location of the calling device.

11. A communication system comprising:
a location module for obtaining a current location for locating a calling device;
a place call module, coupled to the location module, for identifying a caller number for identifying the calling device; and
a caller location module, coupled to the place call module, for selecting a caller location label based on the caller number and the current location for personalizing a description of the current location of the calling device, and for displaying on a receiving device.

12. The system as claimed in claim 11 further comprising a receive call module is for receiving a caller submitted label for displaying on the receiving device, the caller submitted label being a personalized description of the location of the receiving device.

13. The system as claimed in claim 11 wherein:
the place call module is for receiving a caller submitted label for displaying on the receiving device, the caller submitted label being a personalized description of the location of the receiving device; and
further comprising:
a receive call module, coupled to the caller location module, for overriding the caller submitted label with the current location with a privacy override.

14. The system as claimed in claim 11 further comprising a time detail module, coupled to the caller location module, is for identifying a time constraint to assert a lower or a higher level of detail in the caller location label.

15. The system as claimed in claim 11 further comprising a privilege detail module, coupled to the caller location module, is for identifying a caller privilege for enabling access to a detail of the caller location label.

16. The system as claimed in claim 11 further comprising:
a time detail module, coupled to the caller location module, is for identifying a time constraint to assert a lower or a higher level of detail in the caller location label; and
a privilege detail module, coupled to the time detail module, is for identifying a caller privilege for enabling access to a detail of the caller location label.

17. The system as claimed in claim 16 further comprising an urgency module, coupled to a receive call module, is for receiving an urgency advisory for displaying on the receiving device.

18. The system as claimed in claim 16 wherein:
the place call module is for receiving a caller submitted label for personalizing a description of the current location of the calling device through an entry at the calling device; and
further comprising:
a receive call module, coupled to the place call module, for superseding the caller location label with the caller submitted label for displaying at the receiving device.

19. The system as claimed in claim 16 further comprising:
the time detail module, coupled to the caller location module, is for identifying the time constraint to assert a lower or a higher level of detail in the caller location label; and
an update module, coupled to the caller location module, is for updating the caller location label with the time constraint.

20. The system as claimed in claim 16 further comprising an update module, coupled to the caller location module, is for disassociating the caller submitted label with the current location of the calling device.
